(19) United States
(12) Patent Application Publication
(10) Pub. No.: US 2008/0106670 A1
(43) Pub. Date: May 8, 2008

(54) Backlight module having a fastening structure and liquid crystal display using the same

(75) Inventors: Cheng-Fan Chang, Miao-Li (TW); Chih-Ching Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/982,944

(22) Filed: Nov. 5, 2007

(30) Foreign Application Priority Data
Nov. 3, 2006 (TW) 95140754

(51) Int. Cl. G02F 1/13357; F21V 8/00

(52) U.S. Cl. 349/58; 362/621

(57) ABSTRACT

An exemplary backlight module (20) used in a liquid crystal display (2) includes a frame (23) with a supporting board (231), a flexible printed circuit board (21), a light guide plate (27) received in the frame, and a fastening plate (222). The supporting board includes a side wall (233). The flexible printed circuit board includes a plurality of light emitting units (25) attached thereon. The light guide plate includes a light incident surface (26). The fastening plate is engaged with the side wall of the supporting board, thereby fixing the flexible printed circuit board on the frame with the light emitting units being located adjacent and opposite to the light incident surface of the light guide plate.

### FIELD OF THE INVENTION

The present invention relates to backlight modules, such as those used in liquid crystal displays (LCDs); and, particularly, to a backlight module that has a fastening structure for securing components such as light emitting units in position. The present invention also relates to an LCD using the backlight module.

### GENERAL BACKGROUND

Liquid crystal of an LCD does not itself emit light. Rather, the liquid crystal relies on receiving light from a source such as ambient sunlight or a backlight that is installed with the LCD. Thus a typical LCD has a backlight module installed therewith. The backlight module provides a uniform flat light source that enables the LCD to display images.

A typical backlight module mainly includes a light source, a light guide plate (LGP), a flexible printed circuit board (FPCB), a plurality of optical films (e.g. diffusers, brightness enhancement films, reflector, etc), and a frame for receiving the various components of the backlight module.

FIG. 8 is an exploded, isometric view of a conventional backlight module. The backlight module 10 includes an LGP 17, an FPCB 11, a plurality of light emitting units 15 attached on the FPCB 11, a double-sided adhesive tape 19, and a frame 13 for receiving the LGP 17, the FPCB 11, and the double-sided adhesive tape 19.

The LGP 17 includes a light incident surface 16. The frame 13 includes a frame-shaped supporting board 131. A plurality of notches 132 is defined in a side wall 133 of the supporting board 131, for receiving the light emitting units 15 attached on the FPCB 11.

Referring also to FIG. 9, this is an assembled view of the backlight module 10. In assembly, firstly, the LGP 17 is received in the frame 13. Then the FPCB 11 is adhered on the side wall 133 of the supporting board 131 of the frame 13 by the double-sided adhesive tape 19. Thereby, the light emitting units 15 attached on the FPCB 11 are fittingly received in the corresponding notches 132 of the frame 13, with the light emitting units 15 being located adjacent and opposite to the light incident surface 16 of the LGP 17.

Because the FPCB 11 is fixed on the frame 13 by the double-sided adhesive tape 19, it is problematic and inconvenient if for some reason the FPCB 11 needs to re-assembled. For example, in mass production of the backlight module 10, occasionally the light emitting units 15 attached on the FPCB 11 may not be located correctly in position relative to the light incident surface 16 of the LGP 17. In such instances, the FPCB 11 needs to be removed from the double-sided adhesive tape 19 and then re-attached. This kind of re-assembly of the backlight module 10 is inconvenient and time-consuming, and adds to the cost of mass manufacturing the backlight module 10.

Furthermore, because the area for attaching the FPCB 11 on the side wall 133 is limited, it is difficult to ensure that the FPCB 11 is securely attached on the frame 13. The light emitting units 15 attached on the FPCB 11 are liable to deviate from their positions relative to the incident surface 16 of the LGP 17. When this happens, some of the light beams emitted from the light emitting units 15 may not enter the incident surface 16 of the LGP 17, and may instead be lost. This means a ratio of utilization of light energy of the backlight module 10 is reduced. In turn, the display characteristics and performance of the associated LCD are diminished.

What is needed, therefore, is a backlight module and an associated liquid crystal display that can overcome the above-described deficiencies.

### SUMMARY

A backlight module for liquid crystal display includes a frame with a supporting board, a flexible printed circuit board, a light guide plate received in the frame, and a fastening plate. The supporting board includes a side wall. The flexible printed circuit board includes a plurality of light emitting units attached thereon. The light guide plate includes a light incident surface. The fastening plate is engaged with the side wall of the supporting board, thereby fixing the flexible printed circuit board on the frame with the light emitting units being located adjacent and opposite to the light incident surface of the light guide plate.

A liquid crystal display includes a liquid crystal panel and a backlight module opposite to the liquid crystal panel. The backlight module includes a frame with a supporting board, a flexible printed circuit board, a light guide plate received in the frame, and a fastening plate. The supporting board includes a side wall. The flexible printed circuit board includes a plurality of light emitting units attached thereon. The light guide plate includes a light incident surface. The fastening plate is engaged with the side wall of the supporting board, thereby fixing the flexible printed circuit board on the frame with the light emitting units being located adjacent and opposite to the light incident surface of the light guide plate.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of an LCD according to a first embodiment of the present invention, the LCD having a backlight module.

FIG. 2 is an enlarged view of a circled portion, labeled II, of FIG. 1.

FIG. 3 is an assembled view of the backlight module of the LCD of FIG. 1.

FIG. 4 is an enlarged, cross-sectional view of part of the backlight module taken along line IV-IV of FIG. 3.

FIG. 5 is a cross-sectional view of a part of a backlight module according to a second embodiment of the present invention.

FIG. 6 is a cross-sectional view of a part of a backlight module according to a third embodiment of the present invention.

FIG. 7 is an exploded, isometric view of an LCD according to a fourth embodiment of the present invention, the LCD having a backlight module.

FIG. 8 is an exploded, isometric view of a conventional backlight module.

FIG. 9 is an assembled view of the backlight module of FIG. 8.

### DETAILED DESCRIPTION OF PREFERRED EMBODIMENTS

Reference will now be made to the drawings to describe the preferred and exemplary embodiments in detail.

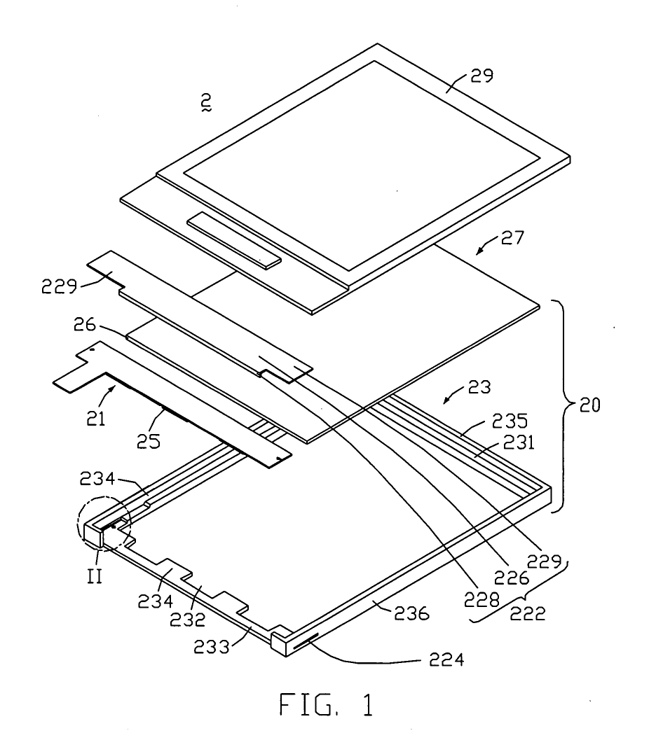

FIG. 1 is an exploded, isometric view of an LCD according to a first embodiment of the present invention. The LCD 2 mainly includes a liquid crystal panel 29, and a backlight module 20 opposite to the liquid crystal panel 29. The liquid crystal panel 29 is for displaying images, and the backlight module 20 is for providing light beams to the liquid crystal panel 29.

The backlight module 20 includes an LGP 27, an FPCB 21, a plurality of light emitting units 25 attached on the FPCB 21, a fastening plate 222, and a frame 23 for receiving the LGP 27, the FPCB 21, the light emitting units 25, and the fastening plate 222. The light emitting units 25 may be light emitting diodes (LEDs). The frame 23 may be made of plastic or metal. The fastening plate 222 may be made of plastic such as polyethylene terephthalate (PET).

The LGP 27 includes a light incident surface 26. The fastening plate 222 includes a generally T-shaped main body 226, and a bent portion 228 perpendicularly extending from a long edge of a stem (not labeled) of the T-shaped main body 226. That is, the bent portion 228 is bent downward from the stem. Opposite arms (not labeled) of the T-shaped main body 226 define two terminals 229, respectively.

The frame 23 includes two generally L-shaped side walls 234 and 236 oriented symmetrically opposite to each other, a straight side wall 235 between the L-shaped side walls 234, 236, and a supporting board 231. Each of the L-shaped side walls 234 and 236 includes a long arm (not labeled) and a short arm (not labeled). The straight side wall 235 interconnects ends of the long arms of the L-shaped side walls 234 and 236. Part of the supporting board 231 perpendicularly extends inward from inner surfaces (not labeled) of the side walls 234, 235, 236. Thereby, the supporting board 231 forms a rectangular closed space (not labeled) for receiving the LGP 27 and the light emitting units 25.

The supporting board 231 includes a side wall 233 adjacent to the short arms of the L-shaped side walls 234 and 236. A plurality of protrusions 234 that parallel with each other extend from an inner surface (not labeled) of the side wall 233 into the closed space. Thereby, a notch 232 is defined between every two adjacent protrusions 234. Each notch 232 is for receiving a respective light emitting unit 25.

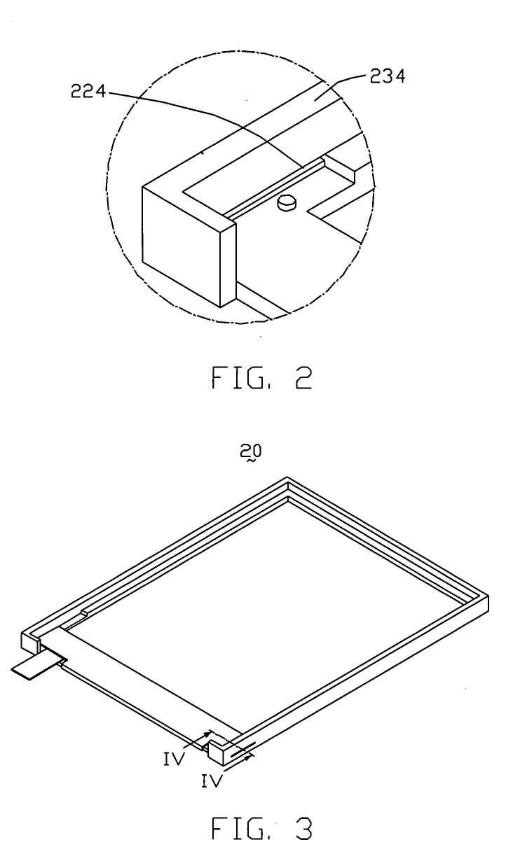

Referring also to FIG. 2, this is an enlarged view of a circled portion II of FIG. 1. Two rectangular slots 224 are defined in ends of the long arms of the L-shaped side walls 234 and 236, respectively. The slots 224 are located adjacent to the side wall 233 of the supporting board 231, and are for receiving the two terminals 229 of the arms of the T-shaped main body 226 of the fastening plate 222.

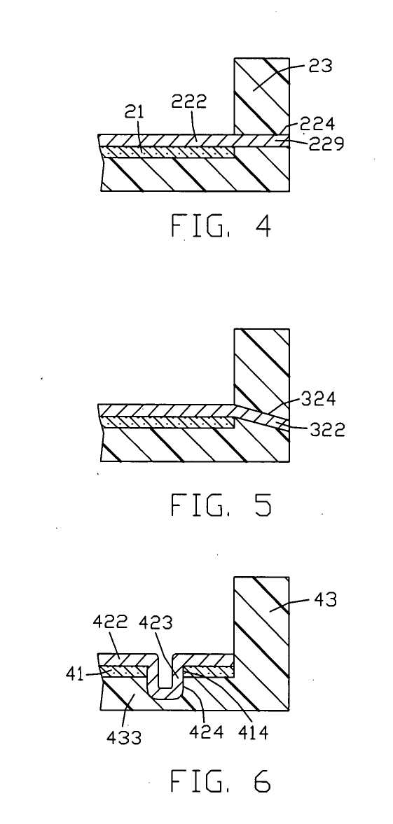

Referring also to FIGS. 3 and 4, these are views relating to the backlight module 20 once it has been assembled. In assembly, firstly, the LGP 27 is received in the frame 23. Then the FPCB 21 is disposed on the side wall 233 of the supporting board 231 of the frame 23. Thereby, the light emitting units 25 attached on the FPCB 21 are fittingly received in the corresponding notches 232 of the side wall 233 of the supporting board 231, with the light emitting units 25 being located adjacent and opposite to the light incident surface 26 of the LGP 27. Finally, the fastening plate 222 is laid over the FPCB 21. The T-shaped main body 226 of the fastening plate 222 is elastically deformed slightly, so that the terminals 229 of the arms of the T-shaped main body 226 are inserted into the corresponding slots 224 of the frame 23 respectively. Preferably, the terminals 229 are interferentially engaged in the slots 224. Thereupon, the bent portion 228 abuts an outside surface (not labeled) of the side wall 233 of the supporting board 231. Thereby, the FPCB 21 is fixed on the frame 23 by the fastening plate 222.

With these configurations, the fastening plate 222 can take the place of a conventional double-sided adhesive tape. The FPCB 21 is fixed on the frame 23 by the fastening plate 222, with the two terminals 229 of the arms of the T-shaped main body 226 engaged in the slots 224 of the frame 23. Once the FPCB 21 is fixed on the frame 13, if necessary, the FPCB 21 can be readily removed or adjusted. This is accomplished simply by fully or partly removing the two terminals 229 from the slots 224 of the frame 23, and removing or adjusting the FPCB 21. Thus, if the light emitting units 25 attached on the FPCB 21 are not correctly in position relative to the light incident surface 26 of the LGP 27, the needed re-assembly or adjustment of the backlight module 20 can be conveniently performed.

Moreover, with the two terminals 229 of the arms of the T-shaped main body 226 of the fastening plate 222 are securely received in the slots 224 of the frame 23. Thereby, the fastening plate 222 can tightly hold the FPCB 21 on the frame 23. Thus, the light emitting units 25 attached on the FPCB 21 can reliably maintain their correct positions relative to the incident surface 26 of the LGP 27, and not deviate therefrom. Over a service life of the backlight module 20, most or even all of the light beams emitted from the light emitting units 25 enter the incident surface 26 of the LGP 27. This enables the backlight module 20 to consistently achieve a high ratio of utilization of light energy, and the LCD 2 to reliably provide good display characteristics.

FIG. 5 is an enlarged, cross-sectional view of a part of a backlight module according to a second embodiment of the present invention. The backlight module (not labeled) has a structure similar to that of the backlight module 20. However, each of two slots 324 slants down from an inside wall to an outside wall of a frame (not labeled). Two terminals (not labeled) of arms (not labeled) of a T-shaped main body (not labeled) of a fastening plate 322 correspondingly slant down inside the two slots 324 of the frame. An FPCB (not labeled) is tightly fixed on the frame by the fastening plate 322, with the terminals of the arms of the T-shaped main body engaged in the corresponding slots 324 of the frame, respectively. Preferably, the terminals are interferentially engaged in the slots 324.

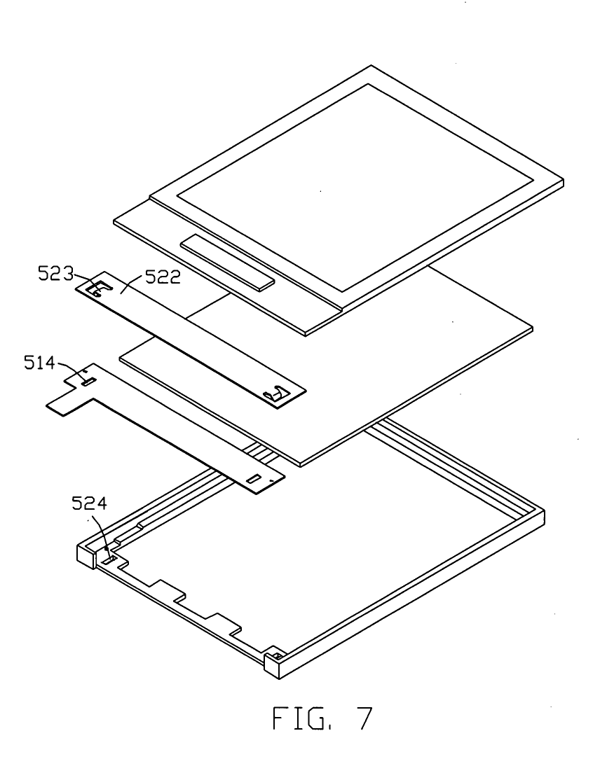

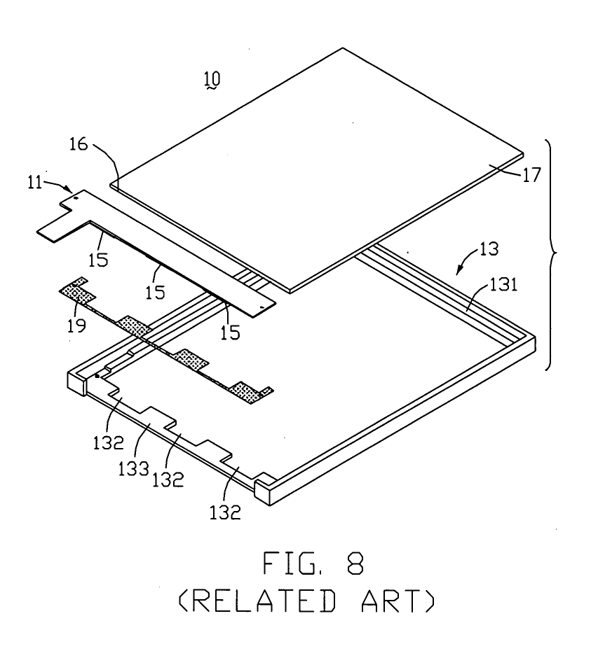

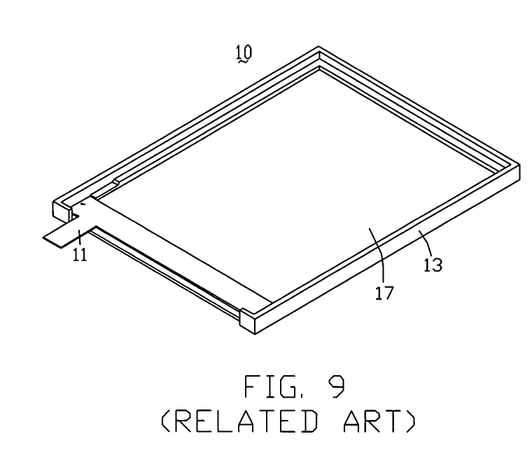

FIG. 6 is an enlarged, cross-sectional view of a part of a backlight module according to a third embodiment of the present invention. The backlight module (not labeled) has a structure similar to that of the backlight module 20. However, a fastening plate 422 includes a pair of U-shaped protrusions 423 (only one shown), corresponding to a pair of holes 414 (only one shown) defined in an FPCB 41, and to a pair of grooves 424 (only one shown) defined in a side wall 433 of a supporting board (not labeled) of a frame 43. Each protrusion 424 extends through the corresponding hole 414 of the FPCB 41 and is interferentially engaged in the corresponding groove 424. Thereby, the FPCB 41 is tightly fixed on the frame 43 by the fastening plate 422.

FIG. 7 is an exploded, isometric view of an LCD according to a fourth embodiment of the present invention. The LCD includes a backlight module (not labeled), which has a structure similar to that of the backlight module 20. However, a fastening plate 522 includes two hooked protrusions 523, corresponding to two holes 514 defined in an FPCB (not labeled), and to two grooves 524 defined in a side wall (not labeled) of a supporting board (not labeled) of a frame (not labeled). In assembly, the hooked protrusions 523 extend through the holes 514 of the FPCB and are engaged in the grooves 524. Thereby, the FPCB is tightly fixed on the frame by the fastening plate 522.

Various modifications and alterations to the above-described embodiments are possible. For example, in the third embodiment, the U-shaped protrusions 424 of the a fastening plate 422, the holes 414 of the FPCB 41, and the grooves 424 in the side wall 433 of the supporting board can instead be other kind of fastening mechanism, such as screws extending through holes of the FPCB 41 and threadedly engaging in screw holes defined in the side wall 433 of the supporting board. In other alternative embodiments, any of the various fastening mechanisms of the different embodiments can be combined together in a single backlight module.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a frame comprising a supporting board, the supporting board comprising a side wall;
a flexible printed circuit board with a plurality of light emitting units attached thereon;
a light guide plate received in the frame, the light guide plate comprising a light incident surface; and
a fastening plate;
wherein the fastening plate is engaged with the side wall of the supporting board, thereby fixing the flexible printed circuit board on the frame with the light emitting units being located adjacent and opposite to the light incident surface of the light guide plate.

2. The backlight module as claimed in claim 1, wherein the fastening plate comprises at least one U-shaped protrusion.

3. The backlight module as claimed in claim 2, wherein the side wall of the supporting board comprises at least one groove, and the at least one U-shaped protrusion is engaged in the at least one groove.

4. The backlight module as claimed in claim 1, wherein the fastening plate comprises at least one hooked protrusion.

5. The backlight module as claimed in claim 4, wherein the side wall of the supporting board comprises at least one groove, and the at least one hooked protrusion is engaged in the at least one groove.

6. The backlight module as claimed in claim 1, wherein the fastening plate comprises two terminals.

7. The backlight module as claimed in claim 6, wherein the frame further comprises two slots, and the terminals of the fastening plate are engaged in the slots of the frame.

8. The backlight module as claimed in claim 7, wherein each of the slots slants down from an inside of the frame to an outside of the frame.

9. The backlight module as claimed in claim 8, wherein each of the terminals of the fastening plate slants down from a main body of the fastening plate to a free end of the terminal.

10. The backlight module as claimed in claim 1, further comprising at least one screw.

11. The backlight module as claimed in claim 10, wherein the side wall of the supporting board comprises at least one screw hole, and the at least one screw is threadedly engaged in the at least one screw hole.

12. The backlight module as claimed in claim 1, wherein the fastening plate comprises a generally T-shaped main body.

13. The backlight module as claimed in claim 12, wherein the fastening plate further comprises a bent portion perpendicularly extending from a stem of the T-shaped main body, and the bent portion abuts an outside surface of the side wall of the supporting board.

14. The backlight module as claimed in claim 1, wherein the fastening plate is made of plastic.

15. The backlight module as claimed in claim 14, wherein the fastening plate is made of polyethylene terephthalate.

16. The backlight module as claimed in claim 1, wherein the frame further comprises two generally L-shaped side walls symmetrically opposite to each other, and a straight side wall, each of the L-shaped side walls comprises a long arm and a short arm, and the straight side wall is between ends of the long arms of the L-shaped side walls.

17. The backlight module as claimed in claim 16, wherein part of the supporting board extends from inner surfaces of the L-shaped side walls and the straight side wall.

18. A liquid crystal display, comprising:
a liquid crystal panel;
a backlight module opposite to the liquid crystal panel, the backlight module comprising:
a frame comprising a supporting board, the supporting board comprising a side wall;
a flexible printed circuit board with a plurality of light emitting units attached thereon;
a light guide plate received in the frame, the light guide plate comprising a light incident surface; and
a fastening plate;
wherein the fastening plate is engaged with the side wall of the supporting board, thereby fixing the flexible printed circuit board on the frame with the light emitting units being located adjacent and opposite to the light incident surface of the light guide plate.
